(19) United States
(12) Patent Application Publication
(10) Pub. No.: US 2026/0171106 A1
(43) Pub. Date: Jun. 18, 2026

(54) METHOD FOR PROCESSING SPEECH SIGNAL, COMPUTER DEVICE AND NON-TRANISTORY COMPUTER-READABLE MEDIUM

(71) Applicant: DOUYIN VISION CO., LTD., Beijing (CN)

(72) Inventors: Xianjun XIA, Beijing (CN); Zhuangqi CHEN, Beijing (CN); Cheng CHEN, Beijing (CN); Yijian XIAO, Beijing (CN)

(21) Appl. No.: 19/128,547

(22) PCT Filed: Feb. 1, 2024
(86) PCT No.: PCT/CN2024/075106

§ 371 Date: May 8, 2025

(30) Foreign Application Priority Data
Feb. 7, 2023 (CN) 202310115479.2

(51) Int. Cl. G10L 25/30; G10L 15/06; G10L 15/22; G10L 21/0208; G10L 21/0232

(52) U.S. Cl. CPC G10L 25/30; G10L 15/063; G10L 15/22; G10L 21/0208; G10L 21/0232

(57) ABSTRACT

Provided in the present disclosure are a method for processing speech signal, an electronic device and a non-transitory computer-readable medium. The method includes: inputting a first superimposition result into an encoding module of a first convolutional recurrent network (CRN) for convolution processing to obtain a local spectral feature; inputting the local spectral feature into a feature processing module of the first CRN to obtain a global spectral feature; inputting the local spectral feature and the global spectral feature into a decoding module of the first CRN for decoding; inputting a decoded result into an activation module of the first CRN to obtain a first mask; performing, based on the first mask, first masking on a complex spectrum obtained through transformation of the speech signal acquired by the microphone of the first terminal device; and obtaining a target speech signal based on the complex spectrum obtained after the first masking.

The present application claims priority to Chinese Patent Application No. 202310115479.2, filed on Feb. 7, 2023, which is incorporated herein by reference in its entirety as part of the present application.

### TECHNICAL FIELD

Embodiments of the present disclosure relate to a method and an apparatus for processing a speech signal, and an electronic device.

### BACKGROUND

In a communication system, interference of acoustic echo affects communication quality. Echo cancellation (Acoustic Echo Cancellation, AEC) aims to suppress useless echo received by a microphone. With the development of Deep Learning (DL), a data-driven AEC model using a deep learning method is proposed.

The AEC method based on DL may use linear acoustic echo cancellation (Linear Acoustic Echo Cancellation, LAEC) to suppress linear components of most echoes. However, the LAEC module is weak in performance, which may lead to distortion of near-end speech.

### SUMMARY

An objective of embodiments of the present disclosure is to provide a method of processing speech signal processing. The method can eliminate echo and keep near-end speech from distortion.

To solve the above technical problem, the embodiments of the present disclosure are implemented through the following aspects.

According to a first aspect, an embodiment of the present disclosure provides a method for processing speech signal. The method includes: inputting a first superimposition result into an encoding module of a first convolutional recurrent network (CRN) for convolution processing to obtain a local spectral feature of the first superimposition result, where the first superimposition result is obtained by superimposing a spectral feature corresponding to a reference signal from a second terminal device and a spectral feature corresponding to a speech signal acquired by a microphone of a first terminal, the second terminal device is in communication with the first terminal, and the speech signal acquired by the microphone of the first terminal includes an echo signal that is acquired by the microphone after the reference signal is played by a speaker of the first terminal; inputting the local spectral feature of the first superimposition result into a feature processing module of the first CRN to obtain a global spectral feature of the first superimposition result; inputting the local spectral feature of the first superimposition result and the global spectral feature of the first superimposition result into a decoding module of the first CRN for decoding; inputting a decoded result into an activation module of the first CRN to obtain a first mask mapped to a predetermined interval; performing, based on the first mask, first masking on a complex spectrum obtained through transformation of the speech signal acquired by the microphone of the first terminal to obtain a complex spectrum obtained after the first masking; and obtaining a target speech signal based on the complex spectrum obtained after the first masking.

According to a second aspect, an embodiment of the present disclosure provides an apparatus for processing speech signal. The apparatus includes: a first extraction module configured to input a first superimposition result into an encoding module of a first convolutional recurrent network (CRN) for convolution processing to obtain a local spectral feature of the first superimposition result, where the first superimposition result is obtained by superimposing a spectral feature corresponding to a reference signal from a second terminal device and a spectral feature corresponding to a speech signal acquired by a microphone of a first terminal, the second terminal device is in communication with the first terminal device, and the speech signal acquired by the microphone of the first terminal comprises an echo signal that is acquired by the microphone after the reference signal is played by a speaker of the first terminal; a second extraction module configured to input the local spectral feature of the first superimposition result into a feature processing module of the first CRN to obtain a global spectral feature of the first superimposition result; a processing module configured to input the local spectral feature of the first superimposition result and the global spectral feature of the first superimposition result into a decoding module of the first CRN for decoding; a mapping module configured to input a decoded result into an activation module of the first CRN to obtain a first mask mapped to a predetermined interval; a masking processing module configured to perform, based on the first mask, the complex spectrum obtained after the first masking on a complex spectrum obtained through transformation of the speech signal acquired by the microphone of the first terminal; and a determining module configured to obtain a target speech signal based on the complex spectrum obtained after the first masking.

According to a third aspect, an embodiment of the present disclosure provides an electronic device. The electronic device includes: a processor; and a memory arranged to store computer-executable instructions that, when executed, cause the processor to implement the steps of the method for processing speech signal according to the first aspect.

According to a fourth aspect, an embodiment of the present disclosure provides a computer-readable medium. The computer-readable medium stores one or more programs that, when executed by an electronic device including a plurality of applications, cause the electronic device, when executed, to implement the steps of the method for processing speech signal according to the first aspect.

In the embodiment of the present disclosure, the first superimposition result is input into the encoding module of the first convolutional recurrent network (CRN) for convolution processing to obtain the local spectral feature of the first superimposition result, where the first superimposition result is obtained by superimposing the spectral feature corresponding to the reference signal from the second terminal device and the spectral feature corresponding to the speech signal acquired by the microphone of the first terminal, the second terminal device is in communication with the first terminal device, and the speech signal acquired by the microphone of the first terminal includes the echo signal that is acquired by the microphone after the reference signal is played by the speaker of the first terminal; the local spectral feature of the first superimposition result is input into the feature processing module of the first CRN to obtain the global spectral feature of the first superimposition result; the local spectral feature of the first superimposition result and the global spectral feature of the first superimposition result are input into the decoding module of the first CRN for decoding; the decoded result is input into the activation module of the first CRN to obtain the first mask mapped to the predetermined interval; the complex spectrum obtained after the first masking is performed, based on the first mask, on the complex spectrum obtained through transformation of the speech signal acquired by the microphone of the first terminal; and the target speech signal is obtained based on the complex spectrum obtained after the first masking. In this manner, echoes can be eliminated and the target speech can be kept from distortion.

### BRIEF DESCRIPTION OF DRAWINGS

To illustrate the embodiments of the present disclosure more clearly, the drawings that need to be used in the embodiments will be briefly described in the following. It is obvious that the drawings in the following description show merely some embodiments of the present disclosure, and those skilled in the art may derive other drawings from these drawings without creative efforts.

FIG. 1 is a flowchart of a method of processing speech signal provided by an embodiment of the present disclosure;

FIG. 2a is a schematic diagram of a network system for processing a speech signal according to an embodiment of the present disclosure;

FIG. 2b is a schematic diagram of convolution processing on a spectral feature map;

FIG. 2c is a schematic diagram of convolution processing on a superimposition result of spectral features;

FIG. 2d is a schematic diagram of extraction of a global spectral feature;

FIG. 3a illustrates a flowchart of a method for processing speech signal provided by an embodiment of the present disclosure;

FIG. 3b illustrates a schematic diagram of a gate mechanism;

FIG. 4 illustrates a flowchart of a method for processing speech signal provided by an embodiment of the present disclosure;

FIG. 5 illustrates a flowchart of a method for processing speech signal provided by an embodiment of the present disclosure;

FIG. 6 illustrates a schematic structural diagram of an apparatus of processing speech signal provided by an embodiment of the present disclosure; and

FIG. 7 is a schematic diagram of hardware structures of an electronic device that performs a method for processing speech signal provided by an embodiment of the present disclosure.

### DETAILED DESCRIPTION

To enable a person skilled in the art to better understand the technical solutions in the present disclosure, the technical solutions in the embodiments of the present disclosure will be described clearly and completely in conjunction with the drawings in the embodiments of the present disclosure. It is obvious that the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

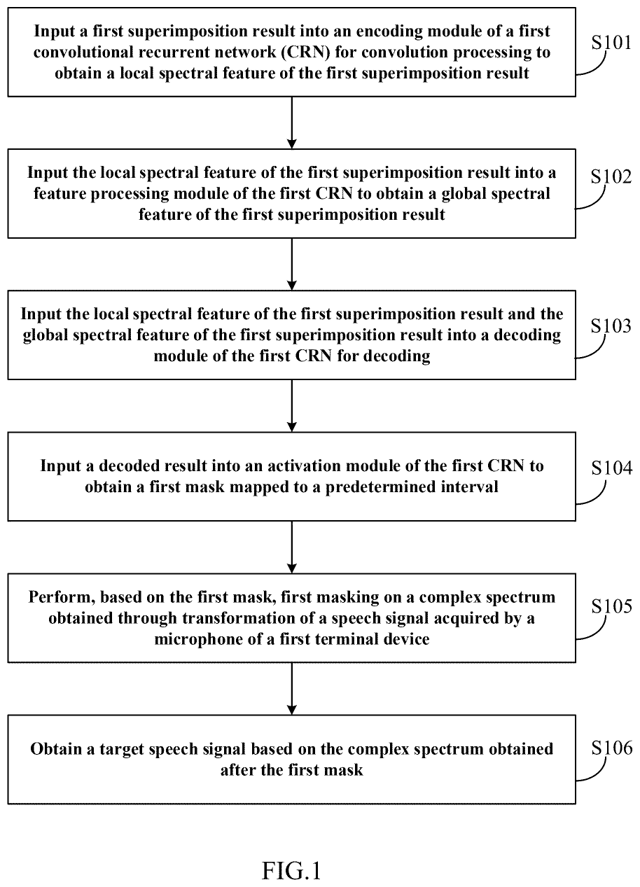

FIG. 1 is a flowchart of a method for processing speech signal provided by an embodiment of the present disclosure. The method may be performed by an electronic device, for example, a terminal device or a server-side device. In other words, the method may be performed by software or hardware installed in the terminal device or the server-side device. The server side includes, but is not limited to, a single server, a server cluster, a cloud server, a cloud server cluster, or the like. As shown, the method may include the following steps.

At step S101, input a first superimposition result into an encoding module of a first convolutional recurrent network for convolution processing to obtain a local spectral feature of the first superimposition result.

In the embodiment of the present disclosure, the convolutional recurrent network (Convolutional recurrent network, CRN) is used as a stem network, thereby avoiding the AEC performance from being weakened and a target speech from being distorted due to slow or poor convergence of the LAEC.

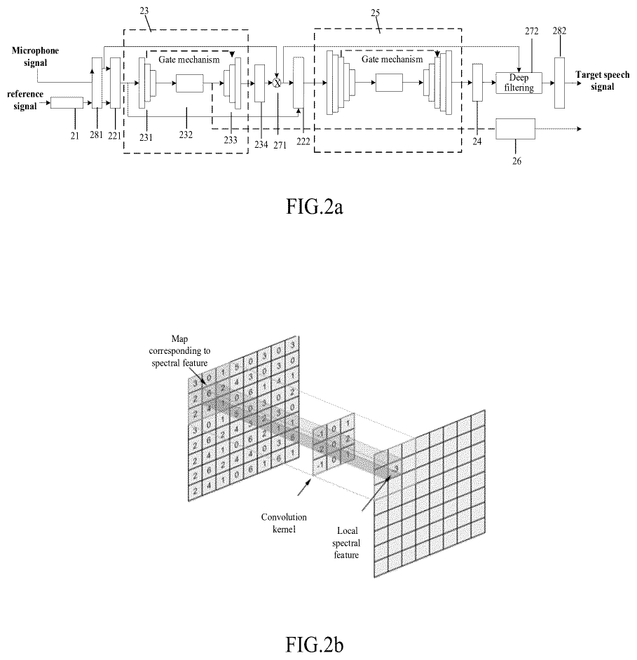

FIG. 2a is a schematic diagram of a network system for processing a speech signal provided by an embodiment of the present disclosure. The first CRN 23 may include: an encoding module 231, a feature processing module 232, a decoding module 233, and an activation module 234. In this step, the first superimposition result is input into the encoding module 231 of the first convolutional recurrent network for convolution processing to obtain the local spectral feature of the first superimposition result.

Specifically, FIG. 2b is a schematic diagram of convolution processing on a spectral feature map. As shown, the spectral feature map corresponding to the speech signal is convolution processed by the convolution kernel to obtain the local spectral feature corresponding to the spectral feature of the speech signal. FIG. 2c is a schematic diagram of convolution processing on a superimposition result of spectral features. As shown, the first superimposition result is obtained by superimposing the spectral feature corresponding to the reference signal from the second terminal device and the spectral feature corresponding to the speech signal acquired by the microphone of the first terminal device, which may be understood as a superimposition of at least two maps.

Similar to FIG. 2b, the first superimposition result is convolution processed by the convolution kernel to obtain the local spectral feature corresponding to the spectral feature of the speech signal. The second terminal device is in communication with the first terminal device, and the speech signal acquired by the microphone of the first terminal device includes the echo signal that is acquired by the microphone after the reference signal is played by the speaker of the first terminal. Specifically, the original speech signal acquired by the microphone includes the above-mentioned echo signal, a noise signal, and the target speech signal.

At step S102, input the local spectral feature of the first superimposition result into the feature processing module of the first CRN to obtain the global spectral feature of the first superimposition result.

FIG. 2d is a schematic diagram of extraction of a global spectral feature. The local spectral feature 2321 of the first superimposition result is input into the feature processing module of the first CRN. Taking an example that an x-axis, a y-axis and a z-axis of the local spectral feature 2321 of the first superimposition result is a time (t) dimension, a frequency (f) dimension, and a channel (c) dimension, respectively, in the feature processing module, the local spectral feature 2321 of the first superimposition result is divided in the f dimension into f blocks 2322 each having a size of c*t. The local spectral feature 2321, originally being a three-dimensional feature, is thus converted into f two-dimensional features, thereby generating input features that can be input into a recurrent neural network (Recurrent Neural Network, RNN). The f two-dimensional features are traversed by the RNN. Similarly, in the feature processing module, the local spectral feature 2321 of the first superimposition result is divided in the t dimension into t blocks 2323 each having a size of c*f. The local spectral feature 2321, originally being a three-dimensional feature, is thus converted into t two-dimensional features, thereby generating input features that can be input into the RNN. The t two-dimensional features are traversed by the RNN. In conclusion, in this step, the global spectral feature of the first superimposition result is obtained through the bidirectional RNN traversal in the f and t dimensions. The feature extraction in the frequency dimension is to establish harmonic dependence, and the feature extraction in the time dimension is to establish long-distance dependence and ensure causality of the model.

At step S103, input the local spectral feature and the global spectral feature of the first superimposition result into a decoding module of the first CRN for decoding.

At step S104, input a decoded result into an activation module of the first CRN to obtain a first mask mapped to a predetermined interval. For example, the activation module uses an activation function (Dense Sigmoid) to map a variable to a predetermined interval [0, 1] to generate the first mask. For example, the first mask is 0.65.

At step S105, perform, based on the first mask, first masking on the complex spectrum obtained through transformation of the speech signal acquired by the microphone of the first terminal.

The first masking 271 is performed, based on the first mask, for example, the first mask being 0.65, on the complex spectrum obtained through transformation of the speech signal acquired by the microphone of the first terminal, that is, the complex spectrum obtained through transformation of the speech signal acquired by the microphone of the first terminal is multiplied by 0.65.

At step S106, obtain the target speech signal based on the complex spectrum obtained after the first masking.

The speech signal acquired by the microphone of the first terminal includes the above-mentioned echo signal, the noise signal, and the target speech signal. For example, the echo signal has a frequency of 2 hertz (Hz), the noise signal has a frequency of 2 Hz, and the target speech signal has a frequency of 6 Hz. Therefore, the total frequency is 10 Hz. In the previous step, the total frequency is multiplied by the first mask 0.65 to obtain 6.5 Hz. The frequency of 6.5 Hz is close to the frequency of 6 Hz. Therefore, the target speech signal can be basically recovered through this step.

In this manner, in the embodiment of the present disclosure, most echoes and noises can be filtered out by using the first model, which can basically keep the target speech at the near end of the first terminal from distortion on the basis of eliminating the echoes.

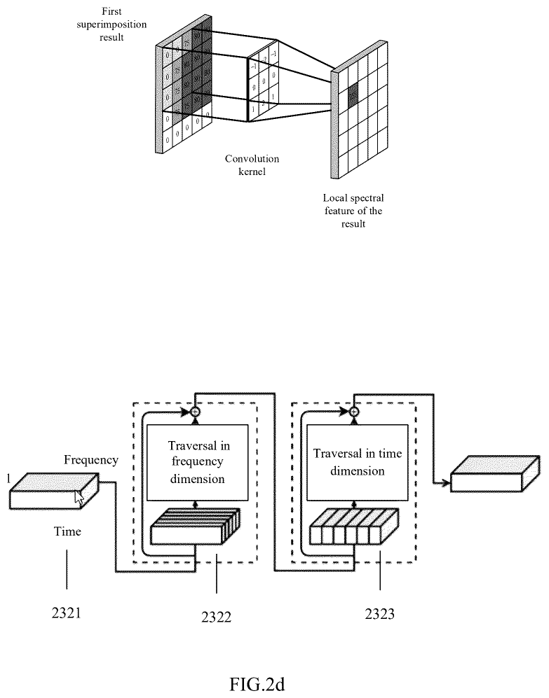

FIG. 3a is a flowchart of a method of processing speech signal provided by an embodiment of the present disclosure. The method may be performed by an electronic device, for example, a terminal device or a server-side device. In other words, the method may be performed by software or hardware installed in the terminal device or the server-side device. The server side includes, but is not limited to, a single server, a server cluster, a cloud server, a cloud server cluster, or the like. As shown, the method may include the following steps.

At step S301, input the first superimposition result into the first CRN to obtain the complex spectrum obtained after the first masking.

For the description of this step, reference may be made to the description of Step S101 to Step S105 in the embodiment of FIG. 1, which is not repeated here.

At step S302, input a second superimposition result into a second CRN to obtain a second mask mapped to a predetermined interval.

Specifically, the second superimposition result is input into an encoding module of the second CRN for convolution processing to obtain a local spectral feature of the second superimposition result, where the second superimposition result is obtained by superimposing a spectral feature corresponding to the complex spectrum obtained after the first masking and the first superimposition result. The local spectral feature of the second superimposition result is input into a feature processing module of the second CRN to obtain a global spectral feature of the second superimposition result. The local spectral feature and the global spectral feature of the second superimposition result are input into a decoding module of the second CRN for decoding. A decoded result is input into an activation module of the second CRN to obtain the second mask mapped to the predetermined interval.

The second CRN and the first CRN may adopt basically the same network structure and processing procedure. For the description of this step, reference may be made to the description of Step S101 to Step S104 in the embodiment of FIG. 1, which is not repeated here. The parameter of the second CRN may be the same as or different from that of the first CRN.

At step S303, perform, by using a deep filtering module and based on the second mask, processing on the complex spectrum obtained after the first masking to obtain a complex spectrum obtained after the second masking.

For the description of this step, reference may be made to the description of Step S105 in the embodiment of FIG. 1, which is not repeated here.

At step S304, obtain the target speech signal based on the complex spectrum obtained after the second masking.

For example, the complex spectrum obtained after the first masking corresponds to a frequency of 6.5 Hz, and the second mask is 0.92. Therefore, 6.5*0.92=5.98 Hz. The frequency corresponding to the complex spectrum obtained after the second masking is 5.98 Hz, and the target speech signal can be basically recovered.

In this manner, in the embodiment of the present disclosure, most echoes and noises are filtered out by using the first CRN, the residual echoes or noises are suppressed by using the second CRN, and the near-end distortion caused by excessive learning of a single model is avoided through the cascade optimization of the two-stage models. Therefore, the near-end speech can be kept from distortion on the basis of eliminating the echoes.

In a possible implementation, in connection with in FIG. 2a, the speech processing model used in the embodiment of the present disclosure may include the first CRN 23 and the second CRN 25. The first CRN 23 may be a coarse-stage model, and the second CRN 25 may be a fine-stage model. Both the coarse-stage and the fine-stage may use the CRN as the stem network.

In a possible implementation, the encoding module 231 of the first CRN includes several two-dimensional convolution blocks. Each two-dimensional convolution block includes: a two-dimensional convolution layer (Conv2D), a batch normalization layer (BatchNorm), and a non-linear activation function (PReLu). The decoding module is symmetrically arranged with the encoding module and includes several transposed two-dimensional convolution blocks. The feature processing module 232 includes two bidirectional gated recurrent units (Gated Recurrent Unit, GRU), for example, FT-GRU. The convolutional recurrent network further includes an activation function (Dense Sigmoid) module 234.

In a possible implementation, the first superimposition result may be input into the two-dimensional convolution layer of the encoding module 231 for the convolution processing; a result of the convolution processing is input into a first batch of normalization layers for mean and variance processing; and a processing result of the first batch of normalization layers is non-linearly activated to obtain the local spectral feature of the first superimposition result. In this manner, the frequency dimension can be compressed to increase the receptive field of the frequency dimension for extraction of the local spectral feature.

In a possible implementation, the local spectral feature of the first superimposition result may be input into a gated unit in the frequency dimension in the feature processing module of the first CRN for traversal to obtain the global spectral feature of the first superimposition result in the frequency dimension. In a possible implementation, the local spectral feature of the first superimposition result may be input into a gated unit in the time dimension in the feature processing module of the first CRN for traversal to obtain the global spectral feature of the first superimposition result in the time dimension; and the global spectral feature of the first superimposition result is obtained based on the global spectral feature of the first superimposition result in the frequency dimension and the global spectral feature of the first superimposition result in the time dimension.

In a possible implementation, a second batch of normalization layers may be input with the global spectral feature of the first superimposition result in the frequency dimension and the global spectral feature of the first superimposition result in the time dimension for mean and variance processing; and a processing result of the second batch of normalization layers is non-linearly activated to obtain the global spectral feature of the first superimposition result.

Optionally, a gate mechanism may be introduced in a skip connection between the encoding module 231 and the decoding module 233. FIG. 3b is a schematic diagram of the gate mechanism. As shown, in each layer of the encoding module 231, the gate mechanism first stacks a decoder output of a previous layer and a corresponding encoder output together, predicts a forget gate through point-by-point convolution (conv1*1) and an activation function (Tanh), applies the forget gate to the output of the previous layer, and finally obtains an output of the present layer through a two-dimensional transposed convolution block.

In an implementation, the first CRN uses a lightweight CRN as the stem network. The parameter configuration of the CRN may be as follows: the encoding module 231 and the decoding module 233 each include eight convolution blocks and transposed convolution blocks. Channel numbers of convolutional layers are {16, 16, 16, 32, 32, 32, 32, 32} in sequence, sizes of convolution kernels are {[5, 1], [1, 5], [6, 5], [4, 3], [6, 5], [5, 3], [3, 5], [3, 3]} in sequence, and convolution steps are {[1, 1], [1, 1], [2, 1], [2, 1], [2, 1], [2, 1], [2, 1], [1, 1]} in sequence. GRU hidden state sizes in the two layers of FT-GRU are {[32, 64], [32, 32]}.

In an implementation, the second CRN 25 may also have the same structure as the first CRN 23 and be processed using similar processing steps. The second CRN may use a larger but still lightweight CRN than the coarse-stage as the stem network, that is, a target parameter in the second CRN is greater than a target parameter in the first CRN 23. At the same time, a fully connected layer is used to predict a CIRM in the form of deep filtering at the end of the model. The parameter configuration of the CRN in the fine-stage is as follows: the encoding and decoding modules each include eight convolution blocks and transposed convolution blocks. Channel numbers of convolutional layers are {16, 16, 32, 32, 64, 64, 64, 64} in sequence, sizes of convolution kernels are {[5, 1], [1, 5], [6, 5], [4, 3], [6, 5], [5, 3], [3, 5], [3, 3]} in sequence, and convolution steps are {[1, 1], [1, 1], [2, 1], [2, 1], [2, 1], [2, 1], [2, 1], [1, 1]} in sequence. GRU hidden state sizes in the two layers of FT-GRU are {[64, 128], [64, 64]}.

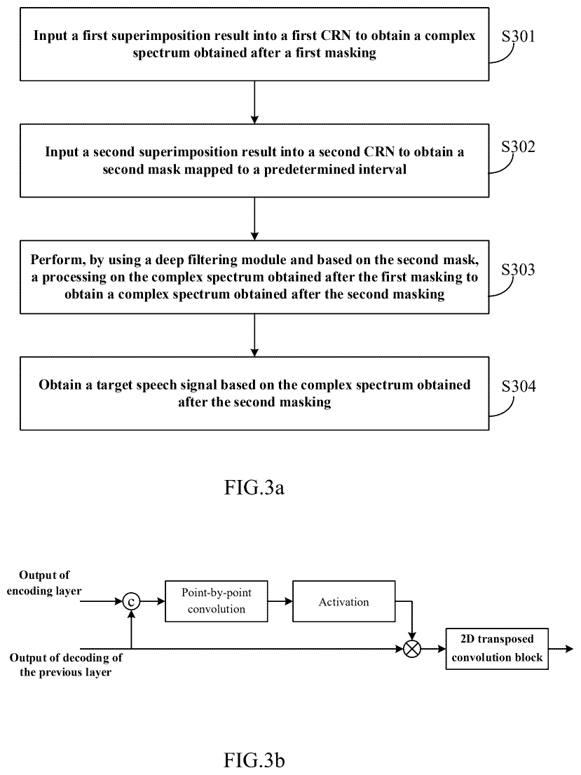

FIG. 4 is a flowchart of a method for processing speech signal provided by an embodiment of the present disclosure. The method may be performed by an electronic device, for example, a terminal device or a server-side device. In other words, the method may be performed by software or hardware installed in the terminal device or the server-side device. The server side includes, but is not limited to, a single server, a server cluster, a cloud server, a cloud server cluster, or the like. As shown, the method may include the following steps.

At step S401, input the first superimposition result into the first CRN to obtain the complex spectrum obtained after the first masking.

For the description of this step, reference may be made to the description of steps S101 to S105 in the embodiment of FIG. 1, which is not repeated here.

At step S402, input the complex spectrum obtained after the first masking and the complex spectrum obtained after the second masking into a speech activity detection module to obtain a speech activity state parameter.

At step S403, determine losses among the target speech signal, the reference signal from the second terminal device, and the speech signal acquired by the microphone of the first terminal through the speech activity state parameter; and adjust the parameter of the first CRN according to the loss.

In connection with FIG. 2a, in this step, to enable the first CRN or the second CRN to have the capability of perceiving the near-end speech, the embodiment of the present disclosure introduces the VAD module for multi-task learning, that is, the VAD module 26 is introduced in the coarse-stage. The configuration of the VAD module 26 is shown in Table 1. The loss (Loss) of the VAD is added to the loss function. The loss function is:

$$L ( S , O ) = MAE ( \vert S \vert , \vert O \vert ) + MAE ( {S}_{r , i} , {O}_{r , i} )$$

$$loss = wL ( S , {O}^{( 1 )} ) + ( 1 - w ) L ( S , {O}^{( 2 )} )$$

$${loss}_{vad} = CrossEntropy ( {P}_{vad} , P )$$

$${loss}_{final} = loss + β {loss}_{vad}$$

S, O⁽¹⁾, and O⁽²⁾∈C^{F×T} respectively represent the complex spectrum of the target near-end signal, the complex spectrum of the near-end signal estimated by the coarse-stage and the fine-stage. P_{vad}∈R^{2×T} and P∈R^{1×T} represent the near-end speech activity state estimated by the coarse-stage and the near-end speech activity detection label, respectively. In the process of training the target model, the output Pvad of the VAD module is fed back to the first CRN to adjust the parameter of the first CRN, which improves the capability of the target model to remove the echo signal and the noise signal in the near-end speech signal.

TABLE 1
Network Configuration Table of Voice
Activity Detection Module (VAD)

| Layer | Input size | Output size |
|---|---|---|
| Conv2D | C × F × T | 16 × F × T |
| BN + PReLu | | |
| F-GRU | 16 × F × T | hidden state [symbol] 8 × 2 × T |
| Reshape | 8 × 2 × T | 16 × T |
| Conv1D | 16 × T | 16 × T |
| BN + PReLu | | |
| Conv1D | 16 × T | 2 × T |

* C, F, and T represent the channel, frequency, and time dimensions, respectively.
* The kernel size and the step of all the convolutional layers are set to 1.

Before or after this step, Steps S302 to S304 in the embodiment of FIG. 3a may also be included to achieve the same effect, which is not repeated here.

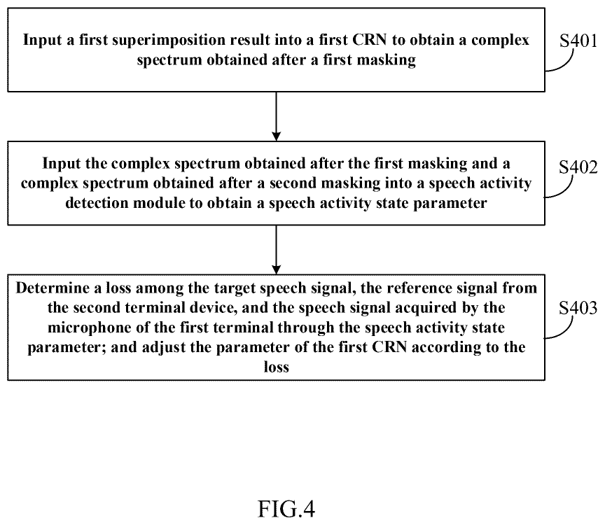

FIG. 5 is a flowchart of a method for processing speech signal provided by an embodiment of the present disclosure. The method may be performed by an electronic device, for example, a terminal device or a server-side device. In other words, the method may be performed by software or hardware installed in the terminal device or the server-side device. The server side includes, but is not limited to, a single server, a server cluster, a cloud server, a cloud server cluster, or the like. As shown, the method may include the following steps.

At step S501, align the reference signal to align the reference signal with the speech signal acquired by the microphone; and perform Fourier transform on the aligned reference signal to obtain a complex spectrum corresponding to the reference signal.

As shown in FIG. 2a, in this step, the time delay control (Time Delay Control, TDC) module 21 may be used to perform alignment on the reference signal x′ (t)∈R^{1×S} and the speech signal γ(t)∈R^{1×S} acquired by the microphone to obtain the aligned reference signal x(t)∈R^{1×S} Fourier transform is performed on the aligned reference signal by the Fourier transform module 281 to transform the reference signal into the frequency domain. Optionally, the aligned reference signal x(t) is subjected to the short-time Fourier transform (Short-Time Fourier Transform, STFT) to obtain the reference signal X(f,t)∈C^{F×T} transformed into the frequency domain, where f represents frequency, t represents time, and C, F, and T represent channel, frequency, and time dimensions respectively. The output of the Fourier transform in this step is the complex spectrum of the reference signal. The real part and the imaginary part of the complex spectrum represent one of the frequency dimension and the time dimension, respectively. For example, the real part represents the frequency and the imaginary part represents the time, or vice versa.

At step S502, perform Fourier transform on the speech signal acquired by the microphone to obtain the complex spectrum corresponding to the speech signal acquired by the microphone.

As shown in FIG. 2a, in this step, the speech signal y(t) acquired by the microphone may be input into the STFT module to obtain the speech signal Y(f,t) acquired by the microphone and transformed into the frequency domain, where f represents frequency and t represents time. The Fourier transform may be the short-time Fourier transform. The output of the Fourier transform in this step is the complex spectrum corresponding to the speech signal acquired by the microphone. The real part and the imaginary part of the complex spectrum represent one of the frequency dimension and the time dimension, respectively. For example, the real part represents the frequency and the imaginary part represents the time, or vice versa.

At step S503, perform modulo operation and power compression on the complex spectrum corresponding to the reference signal and the complex spectrum corresponding to the speech signal acquired by the microphone; and superimpose processing results of the modulo operation and the power compression to obtain the first superimposition result.

Specifically, the first reference signal X(f,t) and the second speech signal Y(f,t) which is acquired by the second microphone may be subjected to the modulo operation and the power compression in the modular compression stack 221, and then are subjected to the stacking operation in the 0^{th} dimension to obtain the first speech signal I_{cprs}=stack ([|X|^{α}, |Y|^{α}]), the first feature signal of the speech signal acquired by the second microphone, where I_{cprs}∈R^{2×F×T}. The modulo operation may obtain the frequency component and the relative amplitude of the signal. In digital signal processing, if the data volume is too large, power compressing may be performed to extract some points for analysis. The CRN cannot directly process the complex spectrum, and the input that may be processed by the CRN may be generated through this step.

The processing results of the modulo operation and the power compression are superimposed to obtain the first superimposition result, so that the CRN can directly process the superimposition result without separately processing results of the modulo operation and power compression corresponding to the complex spectrum of the reference signal and results of the modulo operation and power compression of the complex spectrum of the speech signal of the microphone, thereby improving the data processing efficiency.

At step S504, input the first superimposition result into the first convolutional recurrent network to obtain the target speech signal.

For details, reference may be made to the description of steps S101 to S106 in the embodiment of FIG. 1, which is not repeated here.

In a possible implementation, after the step S105, the present embodiment may further include the following steps. The complex spectrum obtained after the first masking is subjected to the modulo operation and the power compression, and then is superimposed with the first superimposition result to obtain the second superimposition result. The second superimposition result is input into the second CRN to obtain the target speech signal. For details, reference may be made to the description of the embodiment of FIG. 3a, which is not repeated here.

At step S505, perform inverse Fourier transform on the complex spectrum obtained after the first masking to obtain the target speech signal.

For example, in the inverse Fourier transform module 282, the inverse short-time Fourier transform (iSTFT) is performed on the complex spectrum O⁽²⁾ of the target signal to obtain the second near-end signal ŝ(t)∈R^{1×S} The real spectrogram and the imaginary spectrogram of the clean speech are extracted from the noisy speech, and the amplitude response and the phase response of the speech are enhanced at the same time to obtain the speech signal obtained after the echo signal and the noise signal are removed.

If only one model is used for learning, overlearning of the model may be caused, resulting in near-end distortion. In the embodiment of the present disclosure, the cascade optimization is performed by using the two-stage models to avoid the near-end distortion caused by excessive learning of the single model, which can keep the near-end speech from distortion on the basis of eliminating the echoes. In this manner, in the embodiment of the present disclosure, most echoes and noises are filtered out by using the first CRN, the residual echoes or noises are suppressed by using the second CRN, and the near-end distortion caused by excessive learning of the single model is avoided through the cascade optimization of the two-stage models. Therefore, the near-end speech can be kept from distortion on the basis of eliminating echoes.

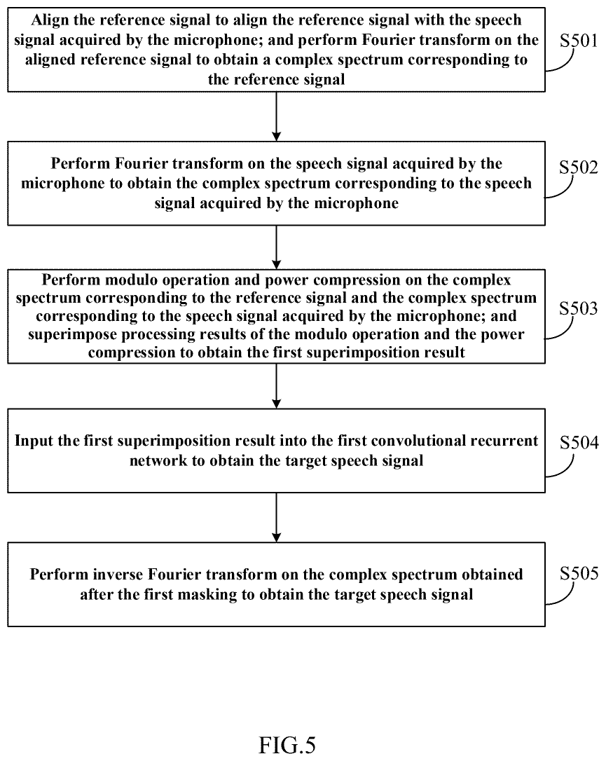

FIG. 6 is a schematic structural diagram of an apparatus of processing speech signal according to an embodiment of the present disclosure. The apparatus 600 includes: a first extraction module 610, a second extraction module 620, a processing module 630, a mapping module 640, a masking processing module 650, and a determining module 660.

The first extraction module 610 is configured to input a first superimposition result into an encoding module of a first convolutional recurrent network (Convolutional Recurrent Network, CRN) for convolution processing to obtain a local spectral feature of the first superimposition result, where the first superimposition result is obtained by superimposing a spectral feature corresponding to a reference signal from a second terminal device and a spectral feature corresponding to a speech signal acquired by a microphone of a first terminal, the second terminal device is in communication with the first terminal device, and the speech signal acquired by the microphone of the first terminal includes an echo signal that is acquired by the microphone after the reference signal is played by a speaker of the first terminal.

The second extraction module 620 is configured to input the local spectral feature of the first [0090] superimposition result into a feature processing module of the first CRN to obtain a global spectral feature of the first superimposition result.

The processing module 630 is configured to input the local spectral feature and the global spectral feature of the first superimposition result into a decoding module of the first CRN for decoding.

The mapping module 640 is configured to input a decoded result into an activation module of the first CRN to obtain a first mask mapped to a predetermined interval.

The masking processing module 650 is configured to perform, based on the first mask, the first masking on the complex spectrum obtained through the transformation of the speech signal acquired by the microphone of the first terminal. The determining module 660 is configured to obtain the target speech signal based on the complex spectrum obtained after the first masking.

In a possible implementation, the processing module 630 is configured to: after obtaining the complex spectrum after the first masking, input a second superimposition result into an encoding module of a second CRN for convolution processing to obtain a local spectral feature of the second superimposition result, where the second superimposition result is obtained by superimposing a spectral feature corresponding to the complex spectrum obtained after the first masking and the first superimposition result; input the local spectral feature of the second superimposition result into a feature processing module of the second CRN to obtain a global spectral feature of the second superimposition result; input the local spectral feature and the global spectral feature of the second superimposition result into a decoding module of the second CRN for decoding; and input a decoded result into an activation module of the second CRN to obtain a second mask mapped to a predetermined interval.

In a possible implementation, the processing module 630 is configured to: after the obtaining the second mask mapped to the predetermined interval, perform, by using a deep filtering module and based on the second mask, processing on the complex spectrum obtained after the first masking to obtain a complex spectrum obtained after the second masking.

In a possible implementation, the processing module 630 is configured to obtain the target speech signal based on the complex spectrum obtained after the second masking.

In a possible implementation, the first extraction module 610 is configured to input the first superimposition result into the two-dimensional convolution layer of the encoding module for the convolution processing; input a result of the convolution processing into a first batch of normalization layers for the mean and variance processing; and non-linearly activate a processing result of the first batch of normalization layers to obtain the local spectral feature of the first superimposition result.

In a possible implementation, the first extraction module 610 is configured to input the local spectral feature of the first superimposition result into the gated unit in the frequency dimension in the feature processing module of the first CRN to obtain the global spectral feature of the first superimposition result in the frequency dimension; input the local spectral feature of the first superimposition result into the gated unit in the time dimension in the feature processing module of the first CRN to obtain the global spectral feature of the first superimposition result in the time dimension; and obtain the global spectral feature of the first superimposition result based on the global spectral feature of the first superimposition result in the frequency dimension and the global spectral feature of the first superimposition result in the time dimension.

In a possible implementation, the first extraction module 610 is configured to input a second batch of normalization layers with the global spectral feature of the first superimposition result in the frequency dimension and the global spectral feature of the first superimposition result in the time dimension for the mean and variance processing; and non-linearly activate a processing result of the second batch of normalization layers to obtain the global spectral feature of the first superimposition result.

In a possible implementation, the first extraction module 610 is configured to: after obtaining the complex spectrum after the second masking, input the complex spectrum obtained after the first masking and the complex spectrum obtained after the second masking into the speech activity detection module to obtain the speech activity state parameter; determine the losses among the target speech signal, the reference signal from the second terminal device, and the speech signal acquired by the microphone of the first terminal through the speech activity state parameter; and adjust the parameter of the first CRN according to the losses.

In a possible implementation, the first extraction module 610 is configured to: before the inputting the first superimposition result into the encoding module of the first convolutional recurrent network (Convolutional Recurrent Network, CRN), align the reference signal to align the reference signal with the speech signal acquired by the microphone; and perform Fourier transform on the aligned reference signal to obtain the complex spectrum corresponding to the reference signal.

In a possible implementation, the first extraction module 610 is configured to: before the inputting the first superimposition result into the encoding module of the first convolutional recurrent network (Convolutional Recurrent Network, CRN), perform Fourier transform on the speech signal acquired by the microphone to obtain the complex spectrum corresponding to the speech signal acquired by the microphone.

In a possible implementation, the first extraction module 610 is configured to: before the inputting the first superimposition result into the encoding module of the first convolutional recurrent network (Convolutional Recurrent Network, CRN), perform the modulo operation and the power compression on the complex spectrum corresponding to the reference signal and the complex spectrum corresponding to the speech signal acquired by the microphone; and superimpose the processing results of the modulo operation and the power compression to obtain the first superimposition result.

In a possible implementation, the first extraction module 610 is configured to, before inputting the second superimposition result into the encoding module of the second CRN, superimpose the first superimposition result with the complex spectrum obtained after the first masking that is subjected to the modulo operation and the power compression to obtain the second superimposition result.

In a possible implementation, the first extraction module 610 performs the inverse Fourier transform on the complex spectrum obtained after the first masking to obtain the target speech signal.

The apparatus 600 provided in the embodiment of the present disclosure can perform the methods described in the foregoing method embodiments and implement the functions and effects of the methods described in the foregoing method embodiments, which is not repeated here.

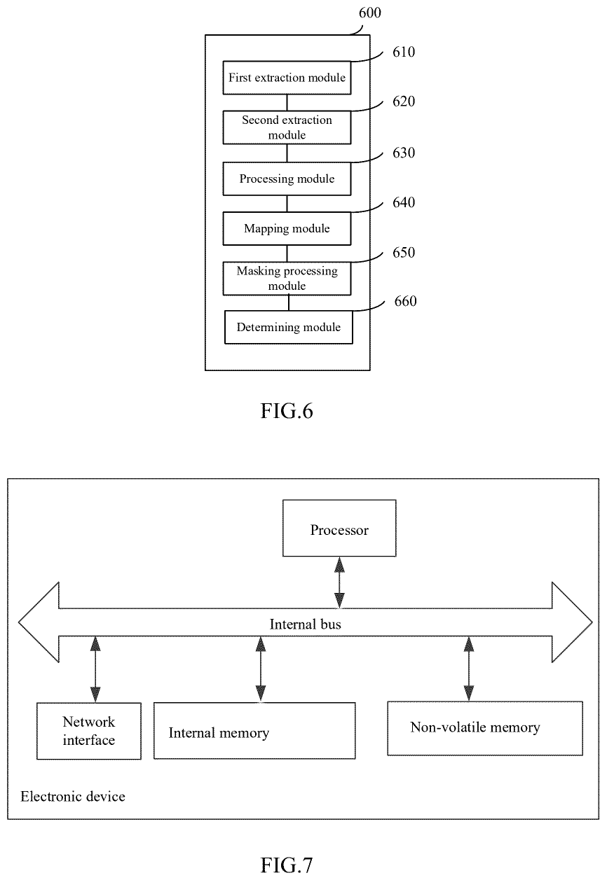

FIG. 7 is a schematic diagram of hardware structures of an electronic device that performs a method for processing speech signal according to an embodiment of the present disclosure. Referring to the figure, at the hardware level, the electronic device includes a processor and, optionally, an internal bus, a network interface, and a memory. The memory may include an internal memory, such as a high-speed random-access memory (Random-Access Memory, RAM), and may also include a non-volatile memory, such as at least one magnetic disk memory. Certainly, the electronic device may further include hardware required for other services.

The processor, the network interface, and the memory may be connected to each other through the internal bus. The internal bus may be an Industry Standard Architecture (ISA) bus, a Peripheral Component Interconnect (PCI) bus, an Extended Industry Standard Architecture (EISA) bus, or the like. The bus may be divided into an address bus, a data bus, a control bus, and the like. For ease of representation, only one bidirectional arrow is used in the figure, but it does not mean that there is only one bus or one type of bus.

The memory is configured to store a program. Specifically, the program may include program code, and the program code includes computer operation instructions. The memory may include the internal memory and the non-volatile memory, and provide the processor with instructions and data.

The processor reads the corresponding computer program from the non-volatile memory into the internal memory and then runs the computer program to form, at a logic level, the apparatus for locating the target user. The processor executes the program stored in the memory and is further configured to perform the processes implemented in the method embodiments shown in FIG. 1, FIG. 3a, FIG. 4, and FIG. 5. To avoid repetition, details are not described herein again.

The method according to the embodiments shown in FIG. 1, FIG. 3a, FIG. 4, and FIG. 5 of the present disclosure may be applied to the processor or executed by the processor. The processor may be an integrated circuit chip and has a signal processing capability. In the implementation process, the steps of the above method may be completed by a hardware integrated logic circuit or software instructions in the processor. The processor may be a general-purpose processor, including a central processing unit (Central Processing Unit, CPU), a network processor (Network Processor, NP), and the like. Alternatively, the processor may be a digital signal processor (Digital Signal Processor, DSP), an application specific integrated circuit (Application Specific Integrated Circuit, ASIC), a field programmable gate array (Field Programmable Gate Array, FPGA), another programmable logic device, a discrete gate or transistor logic device, or a discrete hardware component. Various methods, steps, and logic block diagrams disclosed in the embodiments of the present disclosure may be implemented or performed. The general-purpose processor may be a microprocessor, or the processor may be any conventional processor. The steps of the method disclosed in the embodiments of the present disclosure may be directly embodied as being executed and completed by a hardware decoder processor, or may be executed and completed by a combination of hardware and software modules in the decoder processor. The software module may be located in a random access memory, a flash memory, a read-only memory, a programmable read-only memory or an electrically erasable programmable memory, a register, or another mature storage medium in the art. The storage medium is located in the memory, and the processor reads information from the memory and completes the steps of the above method in combination with the hardware thereof.

The electronic device may further perform the methods described in the method embodiments shown in FIG. 1, FIG. 3a, FIG. 4, and FIG. 5 and implement the functions and beneficial effects of the methods described in the method embodiments described above, which are not described herein again.

Certainly, in addition to the software implementation, the electronic device of the present disclosure does not exclude other implementations, such as a logic device or a combination of software and hardware. That is, the execution body of the following processing procedure is not limited to each logic unit, and may also be a hardware or a logic device.

An embodiment of the present disclosure further provides a computer-readable storage medium. The computer-readable medium stores one or more programs that, when executed by an electronic device including a plurality of applications, cause the electronic device to perform the processes implemented in the method embodiments shown in FIG. 1, FIG. 3a, FIG. 4, and FIG. 5. To avoid repetition, details are not described herein again.

The computer-readable storage medium includes a read-only memory (abbreviated as ROM), a random-access memory (abbreviated as RAM), a magnetic disk, an optical disc, or the like.

Further, an embodiment of the present disclosure further provides a computer program product. The computer program product includes a computer program stored on a non-transitory computer-readable storage medium, where the computer program includes program instructions, when the program instructions are executed by a computer, the processes in the method embodiments shown in FIG. 1, FIG. 3a, FIG. 4, and FIG. 5 are performed. To avoid repetition, details are not described herein again.

In conclusion, the above are merely preferred embodiments of the present disclosure and are not intended to limit the protection scope of the present disclosure. Any modification, equivalent replacement, improvement and so on made within the spirit and principles of the present disclosure shall fall within the protection scope of the present disclosure.

The system, apparatus, module, or unit illustrated in the above embodiments may be implemented by a computer chip or entity, or may be implemented by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or any combination thereof.

The computer-readable medium includes permanent and non-permanent, removable and non-removable media and may store information by any method or technology. The information may be computer-readable instructions, data structures, program modules, or other data. Examples of the computer storage medium include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassette, magnetic tape, magnetic disk storage or other magnetic storage devices, or any other non-transmission medium that may be used to store information accessible by a computing device. As defined herein, the computer-readable medium does not include transitory computer-readable media (transitory media) such as modulated data signals and carrier waves.

It should be further noted that the term “include”, “comprise” or any other variation thereof is intended to cover a non-exclusive inclusion, so that a process, method, commodity, or device that includes a list of elements not only includes those elements, but also includes other elements not expressly listed, or further includes elements inherent to such a process, method, commodity, or device. Without more restrictions, an element defined by the statement “include or comprise one . . . ” does not exclude the presence of additional identical elements in the process, method, commodity, or device that includes the element.

Various embodiments in the present disclosure are described in a progressive manner, and the same or similar parts between the various embodiments may be referred to each other, and each embodiment focuses on the differences from other embodiments. In particular, for the system embodiment, since it is basically similar to the method embodiment, the description is relatively simple, and reference may be made to the description of the method embodiment for the relevant parts.

1. A method for processing speech signal, wherein the method is performed by a first terminal device and comprises:
inputting a first superimposition result into an encoding module of a first convolutional recurrent network (CRN) for convolution processing to obtain a local spectral feature of the first superimposition result, wherein the first superimposition result is obtained by superimposing a spectral feature corresponding to a reference signal from a second terminal device and a spectral feature corresponding to a speech signal acquired by a microphone of the first terminal device, the second terminal device is in communication with the first terminal device, and the speech signal acquired by the microphone of the first terminal device comprises an echo signal that is acquired by the microphone after the reference signal is played by a speaker of the first terminal device;
inputting the local spectral feature of the first superimposition result into a feature processing module of the first CRN to obtain a global spectral feature of the first superimposition result;
inputting the local spectral feature of the first superimposition result and the global spectral feature of the first superimposition result into a decoding module of the first CRN for first decoding;
inputting a first decoded result into an activation module of the first CRN to obtain a first mask mapped to a predetermined interval;
performing, based on the first mask, first masking on a complex spectrum obtained through transformation of the speech signal acquired by the microphone of the first terminal device; and
obtaining a target speech signal based on the complex spectrum obtained after the first masking.

2. The method according to claim 1, after obtaining the complex spectrum after the first masking, further comprising:
inputting a second superimposition result into an encoding module of a second CRN for convolution processing to obtain a local spectral feature of the second superimposition result, wherein the second superimposition result is obtained by superimposing spectral features corresponding to the complex spectrum obtained after the first masking and the first superimposition result;
inputting the local spectral feature of the second superimposition result into a feature processing module of the second CRN to obtain a global spectral feature of the second superimposition result;
inputting the local spectral feature of the second superimposition result and the global spectral feature of the second superimposition result into a decoding module of the second CRN for second decoding; and
inputting a second decoded result into an activation module of the second CRN to obtain a second mask mapped to a predetermined interval.

3. The method according to claim 2, after the obtaining the second mask mapped to the predetermined interval, further comprising:
performing, by using a deep filtering module and based on the second mask, processing on the complex spectrum obtained after the first masking to obtain a complex spectrum obtained after the second masking.

4. The method according to claim 3, wherein the obtaining the target speech signal based on the complex spectrum obtained after the first masking, comprises:
obtaining the target speech signal based on the complex spectrum obtained after the second masking.

5. The method according to claim 1, wherein the inputting the first superimposition result into the encoding module of the first convolutional recurrent network (CRN) for the convolution processing to obtain the local spectral feature of the first superimposition result, comprises:
inputting the first superimposition result into a two-dimensional convolution layer of the encoding module for the convolution processing;
inputting a result of the convolution processing into a first batch of normalization layers for mean and variance processing; and
non-linearly activating a processing result of the first batch of normalization layers to obtain the local spectral feature of the first superimposition result.

6. The method according to claim 1, wherein the inputting the local spectral feature of the first superimposition result into a feature processing module of the first CRN to obtain a global spectral feature of the first superimposition result, comprises:
inputting the local spectral feature of the first superimposition result into a gated unit in a frequency dimension in the feature processing module of the first CRN to obtain a global spectral feature of the first superimposition result in the frequency dimension;
inputting the local spectral feature of the first superimposition result into a gated unit in a time dimension in the feature processing module of the first CRN to obtain a global spectral feature of the first superimposition result in the time dimension; and
obtaining the global spectral feature of the first superimposition result based on the global spectral feature of the first superimposition result in the frequency dimension and the global spectral feature of the first superimposition result in the time dimension.

7. The method according to claim 6, wherein the obtaining the global spectral feature of the first superimposition result based on the global spectral feature of the first superimposition result in the frequency dimension and the global spectral feature of the first superimposition result in the time dimension, comprises:
inputting a second batch of normalization layers with the global spectral feature of the first superimposition result in the frequency dimension and the global spectral feature of the first superimposition result in the time dimension for mean and variance processing; and
non-linearly activating a processing result of the second batch of normalization layers to obtain the global spectral feature of the first superimposition result.

8. The method according to claim 3, after the obtaining the complex spectrum after the second masking, further comprising:
inputting the complex spectrum obtained after the first masking and the complex spectrum obtained after the second masking into a speech activity detection module to obtain a speech activity state parameter;
determining losses among the target speech signal, the reference signal from the second terminal device, and the speech signal acquired by the microphone of the first terminal device through the speech activity state parameter; and
adjusting parameters of the first CRN according to the loss.

9. The method according to claim 1, before the inputting the first superimposition result into the encoding module of the first convolutional recurrent network (CRN), further comprising:
aligning the reference signal to align the reference signal with the speech signal acquired by the microphone; and
performing Fourier transform on an aligned reference signal to obtain a complex spectrum corresponding to the reference signal.

10. The method according to claim 9, before the inputting the first superimposition result into the encoding module of the first convolutional recurrent network (CRN), further comprising:
performing Fourier transform on the speech signal acquired by the microphone to obtain the complex spectrum corresponding to the speech signal acquired by the microphone.

11. The method according to claim 10, before the inputting the first superimposition result into the encoding module of the first convolutional recurrent network (CRN), further comprising:
performing modulo operation and power compression on the complex spectrum corresponding to the reference signal and the complex spectrum corresponding to the speech signal acquired by the microphone; and
superimposing processing results of the modulo operation and the power compression to obtain the first superimposition result.

12. The method according to claim 2, before the inputting the second superimposition result to the encoding module of the second CRN, further comprising:
after performing the modulo operation and the power compression on the complex spectrum obtained after the first masking, superimposing the first superimposition result with the complex spectrum that is subjected to the modulo operation and the power compression, to obtain the second superimposition result.

13. The method according to claim 9, wherein the obtaining the target speech signal based on the complex spectrum obtained after the first masking, comprises:
performing inverse Fourier transform on the complex spectrum obtained after the first masking to obtain the target speech signal.

14. (canceled)

15. An electronic device, comprising:
at least a processor; and
a memory arranged to store computer-executable instructions, wherein the computer-executable instructions, when executed, cause the processor to perform a method for processing speech signal,
wherein the method comprises:
inputting a first superimposition result into an encoding module of a first convolutional recurrent network (CRN) for convolution processing to obtain a local spectral feature of the first superimposition result, wherein the first superimposition result is obtained by superimposing a spectral feature corresponding to a reference signal from a second terminal device and a spectral feature corresponding to a speech signal acquired by a microphone of the first terminal device, the second terminal device is in communication with the first terminal device, and the speech signal acquired by the microphone of the first terminal device comprises an echo signal that is acquired by the microphone after the reference signal is played by a speaker of the first terminal device;
inputting the local spectral feature of the first superimposition result into a feature processing module of the first CRN to obtain a global spectral feature of the first superimposition result;
inputting the local spectral feature of the first superimposition result and the global spectral feature of the first superimposition result into a decoding module of the first CRN for first decoding;
inputting a first decoded result into an activation module of the first CRN to obtain a first mask mapped to a predetermined interval;
performing, based on the first mask, first masking on a complex spectrum obtained through transformation of the speech signal acquired by the microphone of the first terminal device; and
obtaining a target speech signal based on the complex spectrum obtained after the first masking.

16. A non-transitory computer-readable medium storing one or more programs that, wherein, the one or more programs, when executed by an electronic device comprising at least one application, cause the electronic device to perform a method for processing speech signal,
wherein the method comprises:
inputting a first superimposition result into an encoding module of a first convolutional recurrent network (CRN) for convolution processing to obtain a local spectral feature of the first superimposition result, wherein the first superimposition result is obtained by superimposing a spectral feature corresponding to a reference signal from a second terminal device and a spectral feature corresponding to a speech signal acquired by a microphone of the first terminal device, the second terminal device is in communication with the first terminal device, and the speech signal acquired by the microphone of the first terminal device comprises an echo signal that is acquired by the microphone after the reference signal is played by a speaker of the first terminal device;
inputting the local spectral feature of the first superimposition result into a feature processing module of the first CRN to obtain a global spectral feature of the first superimposition result;
inputting the local spectral feature of the first superimposition result and the global spectral feature of the first superimposition result into a decoding module of the first CRN for first decoding;
inputting a first decoded result into an activation module of the first CRN to obtain a first mask mapped to a predetermined interval;
performing, based on the first mask, first masking on a complex spectrum obtained through transformation of the speech signal acquired by the microphone of the first terminal device; and
obtaining a target speech signal based on the complex spectrum obtained after the first masking.

17. The method according to claim 4, after the obtaining the complex spectrum after the second masking, further comprising:
inputting the complex spectrum obtained after the first masking and the complex spectrum obtained after the second masking into a speech activity detection module to obtain a speech activity state parameter;
determining losses among the target speech signal, the reference signal from the second terminal device, and the speech signal acquired by the microphone of the first terminal through the speech activity state parameter; and
adjusting parameters of the first CRN according to the loss.

18. The electronic device according to claim 15, wherein after the obtaining the complex spectrum after the first masking, the method further comprises:
inputting a second superimposition result into an encoding module of a second CRN for convolution processing to obtain a local spectral feature of the second superimposition result, wherein the second superimposition result is obtained by superimposing spectral features corresponding to the complex spectrum obtained after the first masking and the first superimposition result;
inputting the local spectral feature of the second superimposition result into a feature processing module of the second CRN to obtain a global spectral feature of the second superimposition result;
inputting the local spectral feature of the second superimposition result and the global spectral feature of the second superimposition result into a decoding module of the second CRN for decoding; and
inputting a decoded result into an activation module of the second CRN to obtain a second mask mapped to a predetermined interval.

19. The electronic device according to claim 18, wherein after the obtaining the second mask mapped to the predetermined interval, the method further comprises:
performing, by using a deep filtering module and based on the second mask, processing on the complex spectrum obtained after the first masking to obtain a complex spectrum obtained after the second masking.

20. The electronic device according to claim 19, wherein the obtaining the target speech signal based on the complex spectrum obtained after the first masking, comprises:
obtaining the target speech signal based on the complex spectrum obtained after the second masking.

21. The electronic device according to claim 15, wherein the inputting the first superimposition result into the encoding module of the first convolutional recurrent network (CRN) for the convolution processing to obtain the local spectral feature of the first superimposition result, comprises:
inputting the first superimposition result into a two-dimensional convolution layer of the encoding module for the convolution processing;
inputting a result of the convolution processing into a first batch of normalization layers for mean and variance processing; and
non-linearly activating a processing result of the first batch of normalization layers to obtain the local spectral feature of the first superimposition result.
